(19) United States
(12) Patent Application Publication
(10) Pub. No.: US 2026/0304072 A1
(43) Pub. Date: Oct. 1, 2026

(54) LOCATION AWARE MOBILITY MANAGEMENT IN RADIO COMMUNICATION NETWORKS

(71) Applicant: Telefonaktiebolaget LM Ericsson (publ), Stockholm (SE)

(72) Inventors: Fredrik WOXBERG, Västra Frölunda (SE); Mikael KJELLBERG, Mölndal (SE)

(73) Assignee: Telefonaktiebolaget LM Ericsson (publ), Stockholm (SE)

(21) Appl. No.: 19/475,855

(22) PCT Filed: Apr. 20, 2023
(86) PCT No.: PCT/SE2023/050360

§ 371 Date: Oct. 16, 2025

(51) Int. Cl. H04W 4/029

(52) U.S. Cl. CPC H04W 4/029

(57) ABSTRACT

The present disclosure relates to a control arrangement (200) adapted to control a confined area, CA, communication network (100) that is adapted to serve a pre-defined area (101) that comprises a plurality of sub-areas (110, 111, 112, 113, 114, 115, 116, 117, 118; 120, 121, 122), where each sub-area (110, 111, 112, 113, 114, 115, 116, 117, 118; 120, 121, 122) is covered by a corresponding antenna arrangement (510). The control arrangement (200) is adapted to communicate with one or more pieces of internal user equipment (140, 141, 142), UEs, within the CA communication network (100), and with at least one external communication network (150, 151, 152; 260). The control arrangement (200) is furthermore adapted to associate at least one of the internal UEs (140, 141, 142) within the CA communication network (100) with a corresponding specific sub-area (110, 111, 112, 113, 114, 115, 116, 117, 118; 120, 121, 122) in the plurality of sub-areas (110, 111, 112, 113, 114, 115, 116, 117, 118; 120, 121, 122).

### TECHNICAL FIELD

The present disclosure relates to a control arrangement adapted to control a confined area, CA, communication network that is adapted to serve a pre-defined area that comprises a plurality of sub-areas. Each sub-area is covered by a corresponding antenna arrangement.

### BACKGROUND

Recent cellular communication networks, such as the fifth generation (5G) systems defined by the third generation partnership program (3GPP) often use more than one radio unit, or transmission point (TRP), to cover a given service area by means of corresponding antenna arrangements, i.e., some geographical region or a floor of a multistore building.

Traditional coverage by each radio unit is often divided into spatially separated sub-areas, e.g., sectors. Indoor and at other confined or otherwise defined areas, separate confined area (CA) communication networks can be deployed to satisfy local/private needs but also to extend the coverage of external communication networks such as public Wide Area (WA) communication networks. Such CA communication networks may be owned and managed by stakeholders other than the traditional communication network owners such as enterprises or neutral hosts.

CA communication networks have to be planned for interworking with external communication networks e.g. when operating on shared frequencies or when user/device mobility between communication networks is needed.

Many CA communication networks, within surrounding external communication networks, add inter-communication network planning complexities and also impact communication network efficiency e.g. due to user equipment (UE) measurements to handle neighbor relations, user mobility requests etc. Internally external communication networks and CA communication networks also need to be planned independently, e.g. regarding cell capacities, to adopt to their respective service and capacity needs. In this context, a user equipment, UE, is any type of user terminal such as a mobile phone, portable or stationary computer etc.

With state of the art radio systems, e.g. 5G, it will become possible to allocate cells to sets of radio units and antenna arrangements more dynamically, e.g., to be energy efficient or adopt capacity versus needs. Surrounding external communication networks often have significant coverage overlap with the CA communication networks, and as a result, UEs will find neighboring cells from external communication networks in many different CA areas.

Neighbors result in need for UEs in a confined area to perform channel measurements which adds to battery and capacity consumption, adds inter-communication network signaling loads and also results in handovers (HOs) or HO attempts also in areas where users should stay in their communication network.

Changes in cell configurations on either communication networks impacts planning on both sides, e.g. relations need to be updated or re-established, and with dynamic cell configurations such as on CA communication networks, maintaining relevant relations becomes significantly more difficult.

It therefore desired to provide control arrangements, communication networks, systems and methods which alleviate the above drawbacks, providing a reliable and efficient handling of UEs that enter, leave and reside withing a confined area.

### SUMMARY

It is an object of the present disclosure to provide control arrangements, communication networks, systems and methods which confer a reliable and efficient handling of UEs that enter, leave and reside withing a confined area.

Said object is obtained by means of a control arrangement adapted to control a confined area, CA, communication network that is adapted to serve a pre-defined area that comprises a plurality of sub-areas, where each sub-area is covered by a corresponding antenna arrangement. The control arrangement is adapted to communicate with one or more pieces of internal user equipment, UEs, within the CA communication network, and with at least one external communication network. The control arrangement is adapted to associate at least one of the internal UEs within the CA communication network with a corresponding specific sub-area in the plurality of sub-areas.

This means that the control arrangement has information regarding within which sub-area a certain UE is served. This information enables the control arrangement to provide a reliable and efficient handling of UEs that enter, leave and reside withing a confined area.

According to some aspects, the control arrangement is adapted to relate signaling for a certain UE either to a unique identity of the specific sub-area in which the UE is served, or to a unique identity of the specific sub-area in which the UE requests to be served.

This means that the control arrangement can acquire information regarding within which sub-area a certain UE is served by means of any type of signaling for that certain UE. According to some further aspects, the signaling relates to mobility for a certain UE.

According to some aspects, the control arrangement is adapted to form cells using the sub-areas and corresponding unique identities for the sub-areas, where the control arrangement is adapted to confer a unique cell identity to each cell, and to form the cells adaptively in dependence of a current need for wireless communication in the pre-defined area.

This means that one or more sub-areas can be combined to form cells adaptively which is beneficial for example during times when the CA communication network is sparsely populated, such as for example during nights. This conserves resources and power when the demand for communication services is low. During times when the CA communication network is more extensively populated and under heavier load, such as for example during office hours the cells are formed correspondingly.

According to some aspects, the control arrangement is adapted to receive signaling regarding mobility for a certain external UE that is served by an external communication network from the external communication network, where the external UE requests to be served by a cell in the CA communication network. The received signaling comprises information regarding a unique cell identity of the specific cell in which the external UE requests to be served.

This means that the control arrangement can acquire information regarding an external UE that requests to be served by a specific cell in the CA network 100, and, in particular, in which specific cell the external UE requests to be served.

According to some aspects, the control arrangement is adapted to receive signaling regarding mobility for a certain internal UE that is served by a specific sub-area in the CA communication network. The received signaling comprises a unique identity regarding the specific sub-area where the internal UE is served.

This means that the control arrangement can acquire information regarding an internal UE that requests to be served by another sub-area in the CA network, and in particular in which sub-area the internal UE requests to be served.

According to some aspects, the mobility comprises handover between the CA communication network and the external communication network. The control arrangement is adapted to admit handover for a UE between the CA communication network and the external communication network only for a subset of the sub-areas.

This means that for an internal UE, the control arrangement admits handover to an external communication network only for certain sub-areas, for example only those sub-areas that comprise an exit and/or entrance. Correspondingly, for an external UE, the control arrangement admits handover to the CA network only for certain sub-areas, for example only those sub-areas that comprise an exit and/or entrance.

This is enabled since the control arrangement is adapted to relate signaling for a certain UE either to a unique identity of the specific sub-area in which the UE is served, or to a unique identity of the specific sub-area in which the UE requests to be served.

According to some aspects, the control arrangement is adapted to exchange information with the external communication network, where the information comprises data regarding one or more UEs that are candidates for handover between the CA communication network and the external communication network.

In this manner, handover requests to sub-areas that do not comprise an exit and/or entrance, or otherwise are unsuitable for handover, are denied. This reduces unnecessary signaling and possible handover toggling between an external communication network and the CA communication network which of course is highly undesirable.

According to some aspects, the control arrangement is adapted to instruct UEs, determined to be present in sub-areas where handover for the UEs between the CA communication network and the external communication network is not admitted, to refrain from at least one of
signaling to the external communication network
initializing handover
performing channel measurements.

In this manner, unnecessary signaling is avoided, which increases the capacity and efficiency of the CA communication network.

According to some aspects, the control arrangement comprises a communication interface arrangement that is adapted to receive information regarding for which sub-areas handover for a UE between the CA communication network and the external communication network is admitted. This means that for which sub-areas handover is admitted between the CA communication network and the external communication network can be changed adaptively.

According to some aspects, the communication interface arrangement is adapted for communication between the control arrangement and
the radio units, and
the external communication network.

According to some aspects, the communication interface arrangement comprises two or more separate communication interfaces.

This means that the communication interface arrangement can be used for communication between many different functions.

According to some aspects, the control arrangement is adapted to form cells using those sub-areas where handover for the UEs between the CA communication network and the external communication network is not admitted.

This means that the sub-areas where handover for the UEs between the CA communication network and the external communication network is admitted are exempt from forming of cell, but always in themselves form separate cells that correspond to the corresponding sub-areas.

This object is also obtained by means of control arrangements, communication networks, communication network systems and methods which are associated with the above advantages.

### BRIEF DESCRIPTION OF THE DRAWINGS

The present disclosure will now be described more in detail with reference to the appended drawings, where:

FIG. 1 shows a schematic top view of a confined area communication network;

FIG. 2 schematically illustrates a confined area communication system;

FIG. 3 shows a schematic top view of a confined area communication network in a first mode of operation;

FIG. 4 shows a schematic top view of a confined area communication network in a second mode of operation;

FIG. 5 schematically illustrates a radio unit;

FIG. 6 shows flowcharts for methods according to the present disclosure;

FIG. 7 shows a computer program product;

FIG. 8 shows flowcharts for methods according to the present disclosure;

FIG. 9 shows further flowcharts illustrating examples for the present disclosure;

FIG. 10 shows sequence diagrams illustrating examples for the present disclosure; and

FIG. 11 illustrates a control unit arrangement according to some aspects of the present disclosure.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

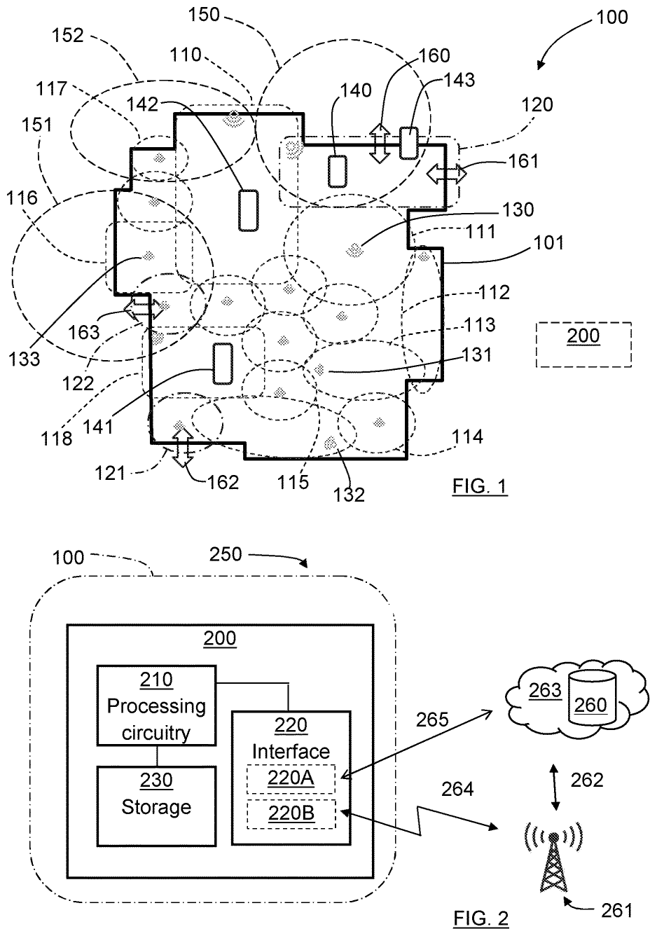

FIG. 1 shows a confined area CA communication network 100 that is adapted to serve a pre-defined area 101 that comprises a plurality of sub-areas 110, 111, 112, 113, 114, 115, 116, 117, 118; 120, 121, 122 marked with short dashed lines and dash-dotted lines (not all indicated in FIG. 1 for reasons of clarity). Each sub-area 110, 111, 112, 113, 114, 115, 116, 117, 118; 120, 121, 122 is covered by a corresponding antenna arrangement 510 as shown in FIG. 5.

The CA communication network 100 comprises a control arrangement 200 and a plurality of radio units 130, 131, 132, 133 lines (only a few indicated in FIG. 1 for reasons of clarity), where each radio unit 130, 131, 132, 133 comprises at least one antenna arrangement 510 and a transceiver unit 520. Each antenna arrangement 510 is adapted to cover a certain sub-area 110, 111, 112, 113, 114, 115, 116, 117, 118; 120, 121, 122.

According to some aspects, at least one antenna arrangement 510 comprises two or more separate antenna units 510A, 510B.

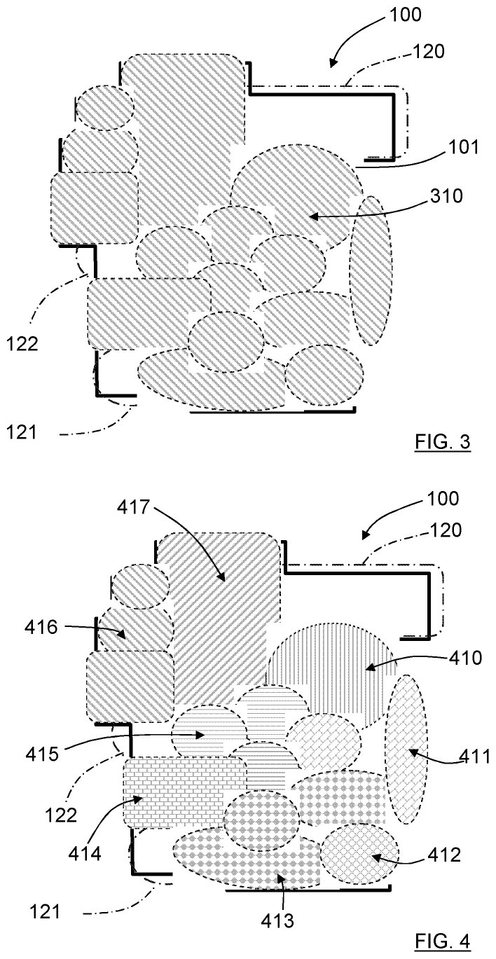

The control arrangement 200 is adapted to communicate with one or more pieces of internal user equipment 140, 141, 142, UEs, within the CA communication network 100, and with at least one external communication network 150, 151, 152; 260. In FIG. 1, three external communication networks 150, 151, 152 are schematically indicated with long dashed lines, and in FIG. 2 there is a remote server 260, external to the CA communication network 100, that according to some aspects is adapted to handle the external communication network 150, 151, 152. The remote server 260 is only to be regarded as indicative of a functionality and can in reality be constituted by several separate units and/or form part of a cloud service 263 that can communicate 262 via a communication network 261.

The control arrangement 200 is a part of the CA communication network 100 and can be comprised within the pre-defined area 101. This is of course not necessary, and the control arrangement 200 can alternatively at least partly, or even completely, be realized remote from the pre-defined area 101, even at a remote server similar to the one described above.

According to the present disclosure, the control arrangement 200 is adapted to associate at least one of the internal UEs 140, 141, 142 within the CA communication network 100 with a corresponding specific sub-area 110, 111, 112, 113, 114, 115, 116, 117, 118; 120, 121, 122 in the plurality of sub-areas 110, 111, 112, 113, 114, 115, 116, 117, 118; 120, 121, 122.

In the present example it is assumed that the control arrangement 200 is adapted to associate all the internal UEs 140, 141, 142 within the CA communication network 100 with a corresponding specific sub-area 120, 118, 110, which means that the control arrangement 200 has information regarding within which sub-area 120, 118, 110 a certain UE 140, 141, 142 is served. This information is useful for many purposes as will be described herein.

It is to be noted that the CA communication network 100 comprises a first sub-area 120 that comprises a first exit and/or entrance 160 and a second 161 exit and/or entrance, a second sub-area 121 that comprises a third exit and/or entrance 162, and a third sub-area 122 that comprises a fourth exit and/or entrance 163. The sub-areas 120, 121, 122 that comprise an exit and/or entrance 160, 161, 162, 163 are marked with dash-dotted lines.

According to some aspects, the control arrangement 200 is adapted to relate signaling for a certain UE 140, 141, 142; 143 either to a unique identity of the specific sub-area 110, 111, 112, 113, 114, 115, 116, 117, 118; 120, 121, 122 in which the UE 140, 141, 142; 143 is served, or to a unique identity of the specific sub-area 110, 111, 112, 113, 114, 115, 116, 117, 118; 120, 121, 122 in which the UE 140, 141, 142; 143 requests to be served. Here the UE can be one of the internal UEs 140, 141, 142 or an external UE 143 that is served by an external network 150.

This means that the control arrangement 200 can acquire information regarding within which sub-area 120, 118, 110 a certain UE 140, 141, 142; 143 is served by means of any type of signaling for that certain UE. According to some further aspects, the signaling relates to mobility for a certain UE 140, 141, 142; 143.

According to some aspects, the control arrangement 200 is adapted to receive signaling regarding mobility for a certain internal UE 140, 141, 142 that is served by a specific sub-area 110, 111, 112, 113, 114, 115, 116, 117, 118; 120, 121, 122 in the CA communication network 100, where the received signaling comprises a unique identity regarding the specific sub-area 110, 111, 112, 113, 114, 115, 116, 117, 118; 120, 121, 122 where the internal UE 140, 141, 142 is served.

This means that the control arrangement 200 can acquire information regarding an internal UE 140, 141, 142 that requests to be served by another sub-area 110, 111, 112, 113, 114, 115, 116, 117, 118; 120, 121, 122 in the CA network 100, and in particular in which sub-area 110, 111, 112, 113, 114, 115, 116, 117, 118; 120, 121, 122 the internal UE 140, 141, 142 requests to be served. According to some aspects, the control arrangement 200 is adapted to form cells 310; 410, 411, 412, 413, 414, 415, 416, 417 using the sub-areas 110, 111, 112, 113, 114, 115, 116, 117, 118; 120, 121, 122 and corresponding unique identities for the sub-areas 110, 111, 112, 113, 114, 115, 116, 117, 118; 120, 121, 122, where the control arrangement 200 is adapted to confer a unique cell identity to each cell, and to form the cells 310; 410, 411, 412, 413, 414, 415, 416, 417 adaptively in dependence of a current need for wireless communication in the pre-defined area 101.

This means that on or more sub-areas can be combined to form cells as exemplified in FIG. 3 and FIG. 4. In FIG. 3 each sub-area 120, 121, 122 that comprise an exit and/or entrance 160, 161, 162, 163 constitutes a corresponding cell 120, 121, 122, all other sub-areas for one 310 indicated with diagonal lines. This is beneficial for example during times when the CA communication network 100 is sparsely populated, such as for example during nights. This conserves resources and power when the demand for communication services is low.

In FIG. 4, each sub-area 120, 121, 122 that comprise an exit and/or entrance 160, 161, 162, 163 constitutes a corresponding cell 120, 121, 122 in the same way as in the example illustrated in FIG. 3. Here, however, a plurality of cells 410, 411, 412, 413, 414, 415, 416, 417 are formed for the other sub-areas 110, 111, 112, 113, 114, 115, 116, 117, 118. This is beneficial for example during times when the CA communication network 100 is more extensively populated and under heavier load, such as for example during office hours. The division into cells is in this example adaptive such that more cells are formed the more load the CA communication network 100 is subjected to. The most fine-gained cellular division is the case when each 110, 111, 112, 113, 114, 115, 116, 117, 118; 120, 121, 122 forms a unique cell, and in this case the when the demand for communication services is high and requires a high degree of power and resource utilization.

According to some aspects, the control arrangement 200 is adapted to receive signaling regarding mobility for a certain external UE 143 that is served by an external communication network 150, 151, 152 from the external communication network 150, 151, 152; 260 where the external UE 143 requests to be served by a cell 310; 410, 411, 412, 413, 414, 415, 416, 417 in the CA communication network 100, where the received signaling comprises information regarding a unique cell identity of the specific cell 310; 410, 411, 412, 413, 414, 415, 416, 417 in which the external UE 143 requests to be served.

This means that the control arrangement 200 can acquire information regarding an external UE 143 that requests to be served by a specific cell 310; 410, 411, 412, 413, 414, 415, 416, 417 in the CA network 100, and, in particular, in which specific cell 310; 410, 411, 412, 413, 414, 415, 416, 417 the external UE 143 requests to be served. This is enabled since the external UE 143 that approaches the CA network 100 receives transmissions from the CA network 100, and based on these transmissions, the external UE 143 can forward information to the external communication network 150, 151, 152 from which information it can be derived in which specific cell 310; 410, 411, 412, 413, 414, 415, 416, 417 the external UE 143 requests to be served. The external communication network 150, 151, 152 then contacts the CA network 100 and requests that the external UE 143 is served in that cell, and based on that the CA network 100 can then determine in which sub-area the external UE 143 is to be served.

By means of the present disclosure, for an internal UE 140, 141, 142, the control arrangement 200 can acquire information regarding within which sub-area a certain UE 140, 141, 142 is served irrespective of in which cell the UE 140, 141, 142 is served. Furthermore, for an external UE 143, the control arrangement 200 can determine in which sub-area the external UE 143 is to be served, based on to which cell 310; 410, 411, 412, 413, 414, 415, 416, 417 in which the external UE 143 requests to be served.

According to some aspects, the control arrangement 200 is adapted to form cells 310; 410, 411, 412, 413, 414, 415, 416 using those sub-areas 110, 111, 112, 113, 114, 115, 116, 117, 118 where handover for the UEs 141, 142 between the CA communication network 100 and the external communication network 150, 151, 152 is not admitted. This means that the sub-areas 120, 121, 122 where handover for the UEs 141, 142 between the CA communication network 100 and the external communication network 150, 151, 152 is admitted are exempt from forming of cell, but always in themselves form separate cells that correspond to the corresponding sub-areas 120, 121, 122 According to some aspects, the mobility comprises handover between the CA communication network 100 and the external communication network 150, 151, 152, where the control arrangement 200 is adapted to admit handover for a UE 140, 141, 142 between the CA communication network 100 and the external communication network 150, 151, 152 only for a subset 120, 121, 122 of the sub-areas 110, 111, 112, 113, 114, 115, 116, 117, 118; 120, 121, 122. This means that for an internal UE 140, 141, 142, the control arrangement 200 admits handover to an external communication network 150, 151, 152 only for certain sub-areas, in this example only those sub-areas 120, 121, 122 that comprise an exit and/or entrance 160, 161, 162, 163. Correspondingly, for an external UE 143, the control arrangement 200 admits handover to the CA network 100 only for certain sub-areas, in this example only those sub-areas 120, 121, 122 that comprise an exit and/or entrance 160, 161, 162, 163.

According to some aspects, in other words, the control arrangement 200 is adapted to admit handover for a UE 140, 141, 142 between the CA communication network 100 and the external communication network 150, 151, 152 only for sub-areas 120, 121, 122 that comprise an exit and/or entrance 160, 161, 162, 163 to the pre-defined area 101. This is enabled since the control arrangement 200 is adapted to relate signaling for a certain UE 140, 141, 142; 143 either to a unique identity of the specific sub-area 110, 111, 112, 113, 114, 115, 116, 117, 118; 120, 121, 122 in which the UE 140, 141, 142; 143 is served, or to a unique identity of the specific sub-area 110, 111, 112, 113, 114, 115, 116, 117, 118; 120, 121, 122 in which the UE 140, 141, 142; 143 requests to be served.

According to some aspects, the control arrangement 200 is adapted to exchange information with the external communication network 150, 151, 152, where the information comprises data regarding one or more UEs 140, 143 that are candidates for handover between the CA communication network 100 and the external communication network 150, 151, 152. For example, an external UE 143 encounters the first sub-area 120 that comprises the first exit and/or entrance 160 and requests handover to the CA communication network 100. The external UE 143 receives signaling from the first sub-area 120 and forwards information regarding that signaling to a remote server 260 that handles the remote network 150 that at the moment serves the external UE 143. That information comprises the unique cell identity of the cell that comprises first sub-area 120, and is sent to the control arrangement 200 of the CA communication network 100, that now becomes aware of that the external UE 143 requests handover to a cell in CA communication network 100. Since the cell comprises the first sub-area 120 that is present among those sub-areas where handover is admitted, the requested handover is performed.

In this manner, handover requests to sub-areas that do not comprise an exit and/or entrance, or otherwise are unsuitable for handover, are denied. This reduces unnecessary signaling and possible handover toggling between an external communication network 150, 151, 152 and the CA communication network 100 which of course is highly undesirable.

According to some aspects, the control arrangement 200 is adapted to periodically or continuously determine in which sub-area 110, 111, 112, 113, 114, 115, 116, 117, 118; 120, 121, 122 in the pre-defined area 101 a UE 140, 141, 142; 143 is present.

According to some aspects, the control arrangement 200 is adapted to instruct UEs 141, 142, determined to be present in sub-areas 110, 111, 112, 113, 114, 115, 116, 117, 118 where handover for the UEs between the CA communication network 100 and the external communication network 150, 121, 152 is not admitted, to refrain from at least one of
signaling to the external communication network 150, 151, 152;
initializing handover; and
performing channel measurements.

In this manner, unnecessary signaling is avoided, which increases the capacity and efficiency of the CA communication network 100.

According to some aspects, the control arrangement 200 comprises a communication interface arrangement 220 that is adapted to receive information regarding for which sub-areas 120, 121, 122 handover for a UE 140 between the CA communication network 100 and the external communication network 150, 151, 152 is admitted. According to some further aspects, the communication interface arrangement 220 is adapted for communication between the control arrangement 220 and
the radio units 130, 131, 132, 133, and
the external communication network (150, 151, 152; 263, 260).

This means that for which sub-areas handover is admitted between the CA communication network and the external communication network can be changed adaptively.

This is illustrated in FIG. 2 that shows a confined area (CA) communication network system 250 comprising the CA communication network 100 as described herein and a remote server 260, where the communication interface arrangement 220 is adapted for communication 262, 264 between the control arrangement 200 and the remote server 260. According to some aspects, as mentioned above, the remote server 260 is adapted to control at least one external network 150, 151, 152.

According to some aspects, the communication interface arrangement 220 is adapted for communication 262, 264 between the control arrangement 100 and the remote server 260 via an external communication network 261 such as an external telecommunication network. According to some further aspects, the communication interface arrangement 220 comprises two or more separate communication interfaces 220A, 220B. In this example, there is a first communication interface 220A that is adapted for direct communication with for example the remote server 260 and/or a cloud service 263 via a wired connection 265, for example a fiber connection. There is also a second communication interface 220B that is adapted for wireless communication with for example the remote server 260 and/or a cloud service 263 via 264, 262 an external communication network 261 such as an external telecommunication network.

This means that the communication interface arrangement can be used for communication between many different functions.

According to some aspects, the control arrangement 200 comprises a memory storage unit 230 and processing circuitry 210.

According to some aspects, the control arrangement 200 is adapted to adaptively determine in which sub-areas handover between the CA communication network 100 and an external communication network 150, 151, 152 is admitted. This can for example be achieved by applying certain policies which determine which sub-areas that are suitable for handover between the CA communication network 100 and an external communication network 150, 151, 152. This can for example change when certain gates/doors are closed certain times.

The present disclosure relates to a control arrangement 200 as described herein, being adapted to control a CA communication network 100 that is adapted to serve a pre-defined area 101 that comprises a plurality of sub-areas 110, 111, 112, 113, 114, 115, 116, 117, 118; 120, 121, 122, where each sub-area 110, 111, 112, 113, 114, 115, 116, 117, 118; 120, 121, 122 is covered by a corresponding antenna arrangement 510. The control arrangement 200 is adapted to communicate with one or more pieces of internal user equipment 140, 141, 142, UEs, within the CA communication network 100, and with at least one external communication network 150, 151, 152; 260. The control arrangement 200 is adapted to associate at least one of the internal UEs 140, 141, 142 within the CA communication network 100 with a corresponding specific sub-area 110, 111, 112, 113, 114, 115, 116, 117, 118; 120, 121, 122 in the plurality of sub-areas 110, 111, 112, 113, 114, 115, 116, 117, 118; 120, 121, 122.

The present disclosure also relates to a CA communication network 100 that is adapted to serve a pre-defined area 101 that comprises a plurality of sub-areas 110, 111, 112, 113, 114, 115, 116, 117, 118; 120, 121, 122. The CA communication network 100 comprises the control arrangement 200 as described herein and a plurality of radio units 130, 131, 132, 133, each radio unit 130, 131, 132, 133 comprising at least one antenna arrangement 510 and a transceiver unit 520. Each antenna arrangement 510 is adapted to cover a certain sub-area 110, 111, 112, 113, 114, 115, 116, 117, 118; 120, 121, 122.

The present disclosure also relates to a CA communication network system 250 comprising the CA communication network 100 as described herein and a remote server 260, where the communication interface arrangement 220 is adapted for communication 262, 264 between the control arrangement 200 and the remote server 260.

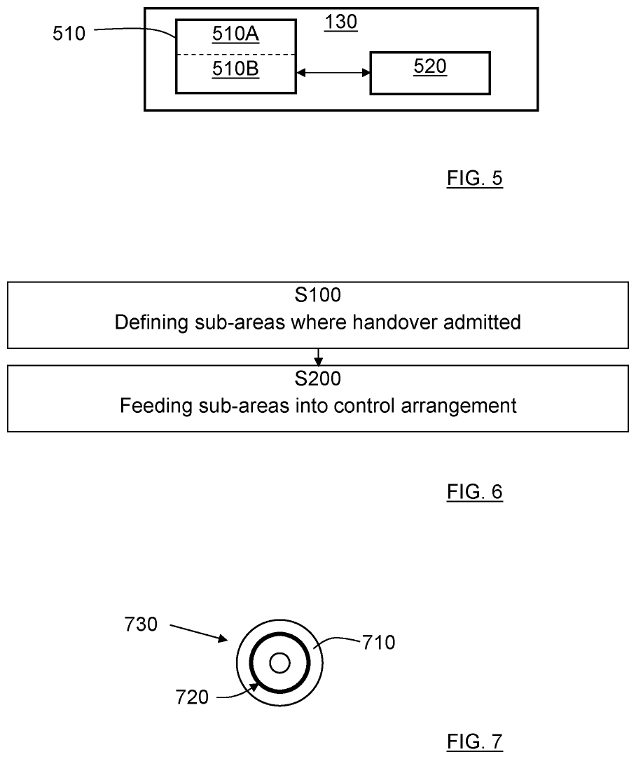

With reference to FIG. 6, the present disclosure also relates to a method in a communication network system 250 as described herein. The method comprises defining S100 those sub-areas 120, 121, 122 where handover for UEs 140 between the CA communication network 100 and the external communication network 150, 151, 152 is to be admitted, and feeding S200 those sub-areas 120, 121, 122 into the control arrangement.

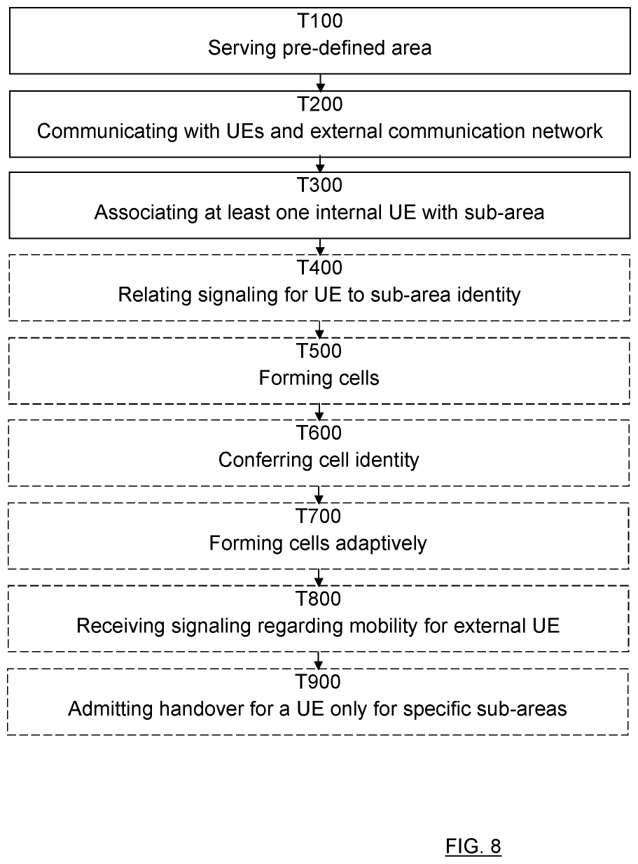

With reference to FIG. 8, the present disclosure also relates to a method in a communication network system 250 as described herein. The method comprises serving T100 a pre-defined area 101 that comprises a plurality of sub-areas 110, 111, 112, 113, 114, 115, 116, 117, 118; 120, 121, 122, where each sub-area 110, 111, 112, 113, 114, 115, 116, 117, 118; 120, 121, 122 is covered by a corresponding antenna arrangement 510. The method further comprises communicating T200 with one or more pieces of internal user equipment 140, 141, 142, UEs, within the CA communication network 100 and with at least one external communication network 150, 151, 152, and associating T300 at least one of the internal UEs 140, 141, 142 within the CA communication network 100 with a corresponding specific sub-area 110, 111, 112, 113, 114, 115, 116, 117, 118; 120, 121, 122 in the plurality of sub-areas 110, 111, 112, 113, 114, 115, 116, 117, 118; 120, 121, 122.

According to some aspects, the method comprises relating T400 signaling for a certain UE 140, 141, 142; 143 either to a unique identity of the specific sub-area 110, 111, 112, 113, 114, 115, 116, 117, 118; 120, 121, 122 in which the UE 140, 141, 142; 143 is served, or to a unique identity of the specific sub-area 110, 111, 112, 113, 114, 115, 116, 117, 118; 120, 121, 122 in which the UE 140, 141, 142; 143 requests to be served.

According to some aspects, the method comprises forming T500 cells 310; 410, 411, 412, 413, 414, 415, 416, 417 using the sub-areas 110, 111, 112, 113, 114, 115, 116, 117, 118; 120, 121, 122 and corresponding unique identities for the sub-areas 110, 111, 112, 113, 114, 115, 116, 117, 118; 120, 121, 122. The method further comprises conferring T600 a unique cell identity to each cell, and forming T700 the cells 310; 410, 411, 412, 413, 414, 415, 416, 417 adaptively in dependence of a current need for wireless communication in the pre-defined area 101.

According to some aspects, the method comprises receiving T800 signaling regarding mobility for a certain external UE 143 that is served by an external communication network 150, 151, 152 from the external communication network 150, 151, 152; 260, where the external UE 143 requests to be served by a cell 310; 410, 411, 412, 413, 414, 415, 416, 417 in the CA communication network 100, where the received signaling comprises information regarding a unique cell identity of the specific cell 310; 410, 411, 412, 413, 414, 415, 416, 417 in which the external UE 143 requests to be served.

According to some aspects, the method comprises receiving signaling regarding mobility for a certain internal UE 140, 141, 142 that is served by a specific sub-area 110, 111, 112, 113, 114, 115, 116, 117, 118; 120, 121, 122 in the CA communication network 100, where the received signaling comprises a unique identity regarding the specific sub-area 110, 111, 112, 113, 114, 115, 116, 117, 118; 120, 121, 122 where the internal UE 140, 141, 142 is served.

According to some aspects, the mobility comprises handover between the CA communication network 100 and the external communication network 150, 151, 152, where the method comprises admitting handover for a UE 140, 141, 142 between the CA communication network 100 and the external communication network 150, 151, 152 only for a subset 120, 121, 122 of the sub-areas 110, 111, 112, 113, 114, 115, 116, 117, 118; 120, 121, 122.

According to some aspects, the method comprises admitting T900 handover for a UE 140, 141, 142 between the CA communication network 100 and the external communication network 150, 151, 152 only for sub-areas 120, 121, 122 that comprise an exit and/or entrance 160, 161, 162, 163 to the pre-defined area 101.

According to some aspects, the method comprises exchanging information with the external communication network 150, 151, 152, where the information comprises data regarding one or more UEs 140 that are candidates for handover between the CA communication network 100 and the external communication network 150, 151, 152.

According to some aspects, the method comprises periodically or continuously determining in which sub-area 110, 111, 112, 113, 114, 115, 116, 117, 118; 120, 121, 122 in the pre-defined area 101 a UE 140, 141, 142; 143 is present.

According to some aspects, the method comprises instructing UEs 141, 142, determined to be present in sub-areas 110, 118 where handover for the UEs between the CA communication network 100 and the external communication network 150, 121, 152 is not admitted, to refrain from at least one of
signaling to the external communication network 150, 151, 152
initializing handover
performing channel measurements.

According to some aspects, the method comprises receiving information regarding for which sub-areas 120, 121, 122 handover for a UE 140 between the CA communication network 100 and the external communication network 150, 151, 152 is admitted.

According to some aspects, the method comprises forming cells 310; 410, 411, 412, 413, 414, 415, 416 using those sub-areas 110, 111, 112, 113, 114, 115, 116, 117, 118 where handover for the UEs 141, 142 between the CA communication network 100 and the external communication network 150, 151, 152 is not admitted.

FIG. 2 schematically illustrates, in terms of a number of functional units, the components of the control arrangement 200 according to embodiments of the discussions herein. Processing circuitry 210 is provided using any combination of one or more of a suitable central processing unit CPU, multiprocessor, microcontroller, digital signal processor DSP, etc., capable of executing software instructions stored in a computer program product, e.g. in the form of a storage medium 230. The processing circuitry 210 may further be provided as at least one application specific integrated circuit ASIC, or field programmable gate array FPGA. The processing circuitry thus comprises a plurality of digital logic components.

Particularly, the processing circuitry 210 is configured to cause the control arrangement 200 to perform a set of operations, or steps. For example, the storage medium 230 may store the set of operations, and the processing circuitry 210 may be configured to retrieve the set of operations from the storage medium 230 to cause the control arrangement 200 to perform the set of operations. The set of operations may be provided as a set of executable instructions. Thus, the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The control arrangement 200 further comprises an interface 220 for communications with at least one external device such as a remote server 260 or the radio units 130, 131, 132, 133. As such the interface 220 may comprise one or more transmitters and receivers, comprising analogue and digital components and a suitable number of ports for wireline communication.

The processing circuitry 210 controls the general operation of the control arrangement 200, e.g. by sending data and control signals to the interface 220 and the storage medium 230, by receiving data and reports from the interface 220, and by retrieving data and instructions from the storage medium 230. Other components, as well as the related functionality, of the control arrangement 200 are omitted in order not to obscure the concepts presented herein.

FIG. 7 shows a computer program product 700 comprising computer executable instructions 710, constituting a computer program 710, stored on media 720 to execute any of the methods disclosed herein.

The present disclosure also relates to a control arrangement 200 adapted to control a confined area, CA, communication network 100 that is adapted to serve a pre-defined area 101 that comprises a plurality of sub-areas 110, 111, 112, 113, 114, 115, 116, 117, 118; 120, 121, 122, where each sub-area 110, 111, 112, 113, 114, 115, 116, 117, 118; 120, 121, 122 is covered by a corresponding antenna arrangement 510. The control arrangement 200 comprises processing circuitry 210 and a storage medium 230, where the storage medium 230 contains a set of operations. The processing circuitry 210 is configured to retrieve the set of operations from the storage medium 230 to cause the control arrangement 200 to communicate with one or more pieces of internal user equipment 140, 141, 142, UEs, within the CA communication network 100, to communicate with at least one external communication network 150, 151, 152; 260, and to associate at least one of the internal UEs 140, 141, 142 within the CA communication network 100 with a corresponding specific sub-area 110, 111, 112, 113, 114, 115, 116, 117, 118; 120, 121, 122 in the plurality of sub-areas 110, 111, 112, 113, 114, 115, 116, 117, 118; 120, 121, 122.

According to some aspects, the processing circuitry 210 is configured to retrieve the set of operations from the storage medium 230 to cause the control arrangement 200 to perform the control arrangement operations described herein.

The present disclosure is not limited to the above, but may vary freely within the scope of the appended claims. For example, the pre-defined area 101 may relate to an office, a store or an outdoor installment such as a sport arena.

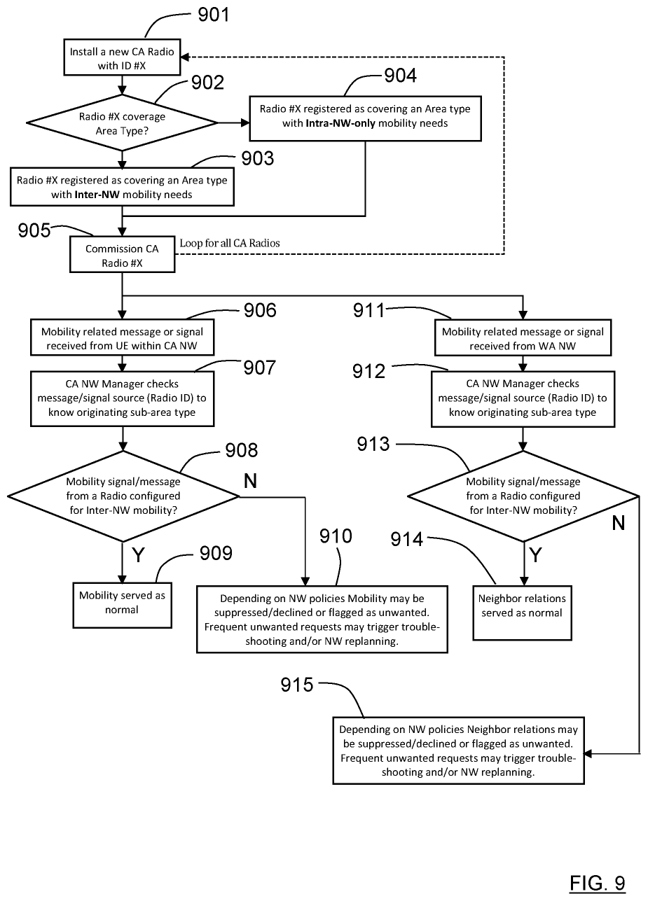

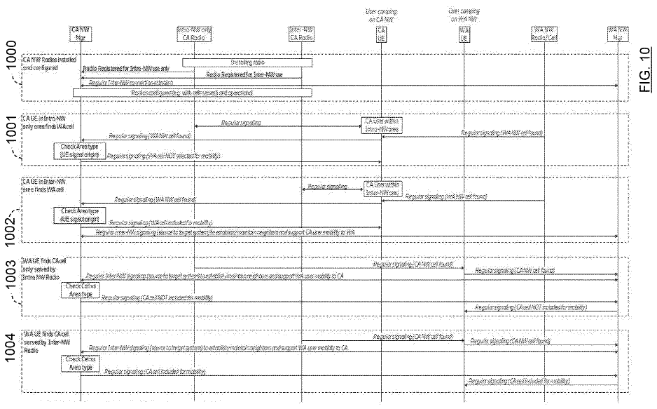

FIG. 9 shows a flowchart that illustrates further methods that are presented as illustrating. examples.

According to some aspects, a new radio unit, CA radio, having a certain unique identification ID #X is installed 901, and then the coverage area type is determined 902. Either the radio unit with ID #X is covering an area with inter-NW (inter-network) mobility needs 903, i.e. between the CA communication network 100 and external communication networks 150, 151, 152, or the radio unit with ID #X is covering an area with intra-NW-only (intra-network only) mobility needs 904, i.e. only within the CA communication network 100.

The CA radio with ID #X is then commissioned 905 and this is repeated for all radio units 130, 131, 132, 133 in the CA communication network 100.

In a first branch, a mobility related message or other signal is received 906 from an internal UE 140, 141, 142, i.e., within the CA communication network 100, and then a CA network manager, in this example the control arrangement 200, checks 907 the message/signal source by identifying the present radio unit's ID #X to know the originating sub-area type. It is then determined 908 if the signal/message comes from a radio unit in a sub-area configured for inter-network mobility, i.e. if for example handover between the CA communication network 100 and an external network 150, 151, 152 is admitted. If yes, the mobility, for example a handover, is served as normal 909. If no, depending on network policies, mobility, for example a handover, may be suppressed/declined or flagged as unwanted 910. Frequent unwanted requests may trigger troubleshooting and/or network replanning In a second branch, a mobility related message or other signal is received 911 from a wide area network (WA NW) and then a CA network manager, in this example the control arrangement 200, checks 912 the message/signal source by identifying the present radio unit's ID #X to know the originating sub-area type. It is then determined 913 if the signal/message comes from a radio unit in a sub-area configured for inter-network mobility, i.e. if for example handover between the CA communication network 100 and an external network 150, 151, 152 is admitted. If yes, the mobility, for example a handover, is served as normal 914. If no, depending on network policies, mobility, for example a handover, may be suppressed/declined or flagged as unwanted 915. Frequent unwanted requests may trigger trouble-shooting and/or network replanning According to some aspects, map, work instructions etc. (with information on mobility need vs areas) used to know how to register the served area type for individual radio units 130, 131, 132, 133 in the CA communication network 100. Registration can be performed by a radio installer, i.e., a physical person, directly into the control arrangement 200, or be automatically detected by the control arrangement 200 if/when the radio units 130, 131, 132, 133 can derive their placement by other means, e.g. from GNSS (Global Navigation Satellite System).

The CA communication network 100 has capability to know which radio unit that carries the signal either by own measurements or by correlating referenced cell identifiers vs the radio unit(s) serving a cell or sub-area.

It should be noted that FIG. 9 only shows an example, illustrating possible aspects of the present disclosure.

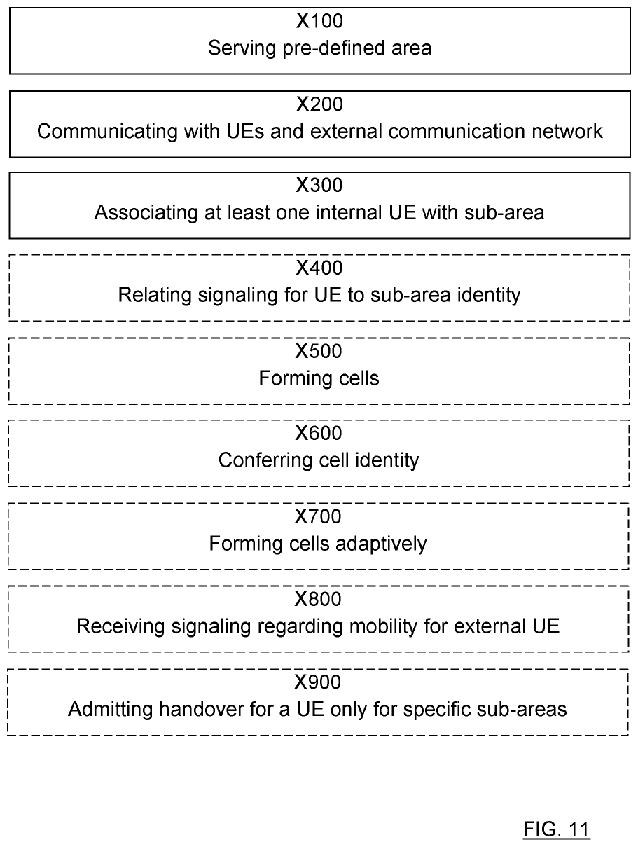

FIG. 10 shows an example sequence diagram that illustrates further aspects of the present disclosure. There is a CA NW Mgr, CA network manager, that in this example is the control arrangement 200. There is also an Intra-NW only CA radio, that in this example is a radio unit that only handles the CA communication network 100 and an Inter-NW CA radio, that in this example is a radio unit that only both the CA communication network 100 and external communication networks 150, 151, 152. There is also a CA UE, an internal UE 140, 141, 142 that is camping on the CA communication network 100 and a WA UE, an external UE 143 that is camping on an external communication network 150, 151, 152. Finally, there is a communication cell 150, 151, 152 in the external communication network and a WA NW manager, a wide area network manager, that in this example may be a remote server 260.

Before operation, there is an initial scenario 1000 where the radio units 130, 131, 132, 133 in the CA communication network 100 are installed in a manner described above with reference to FIG. 9.

In a first scenario 1001, there is an internal UE that resides in a sub-area where mobility such as handover is not admitted, where that UE finds an external communication network cell 150, 151, 152.

In a second scenario 1002, there is an internal UE that resides in a sub-area where mobility such as handover is admitted, where that UE finds an external communication network cell 150, 151, 152. The CA NW Mgr informs the WA NW manager.

In a third scenario 1003, there is an external UE that resides in an external communication network cell 150, 151, 152 and finds a sub-area in the CA communication network 100 where mobility such as handover is not admitted. The CA NW Mgr informs the WA NW manager.

In a fourth scenario 1004, there is an external UE that resides in an external communication network cell 150, 151, 152 and finds a sub-area in the CA communication network 100 where mobility such as handover is admitted. The CA NW Mgr informs the WA NW manager.

It should be noted that FIG. 10 only shows an example, illustrating possible aspects of the present disclosure.

According to some aspects, a “Radio Installer”, for example a person, instructs the CA NW Manager, in the examples described herein the control arrangement 200, in what type of sub-areas different radio units are installed. For radio units covering an area where mobility between the CA communication network 100 and external communication networks 150, 151, 152, is not desired (e.g. because there are no exits/entrances) the Radio Installer registers the radio for “Intra-NW only” use. For radio units covering areas where mobility needs to be supported, they are instead registered for Inter-NW use. Signals carried by radios registered for Inter-NW are treated as usual allowing neighbor relations and mobility between networks as well as within the CA communication network 100, while signals through Intra-NW only registered radios enable the control arrangement 200 to suppress unwanted mobility relations.

According to some aspects, a “CA NW Manager”, in the examples described herein the control arrangement 200, that uses the registered knowledge about what areas the radio units serve to configure own UEs measurements, select where to establish and maintain neighbor relations and where to support user mobility. Irrespective of what logical cell a UE camps on, the control arrangement 200 can keep track of where, in which sub-area, the UE is. UEs within an “Intra-NW only” area can be configured to only measure on CA communication network frequencies and cells, while user in an “Inter-NW” coverage area needs to measure on frequencies and cells related to both external communication networks 150, 151, 152 and the CA communication network 100. When neighbors are found by UEs, the control arrangement 200 can use knowledge of the serving radio, i.e. the UE location, and the registered sub-area type to decide on how to respond to mobility-related requests. If unique cells are allocated to Inter-NW vs Intra-NW radio units, the control arrangement 200 can also suppress unwanted relations and mobility from external UEs served by external communication networks 150, 151, 152. When an external network reports a new neighbor candidate to the CA communication network 100, the control arrangement 200 can check if the cell found is used for Inter-or Intra-NW mobility.

According to some aspects, for sub-areas classified only for Intra-NW mobility, the CA communication network 100 can automatically detect that measuring UEs have found a neighbor in an area where there should not be mobility between the CA communication network 100 and the external communication networks 150, 151, 152. The CA communication network 100 can then decide, based on configured policies, to suppress unwanted neighbor relations to minimize need for coordinated planning, reduce signaling loads, block unwanted handovers etc. The CA communication network 100 can also optimize performance by monitoring request intensities from such sub-areas. If mobility requests are frequent, this tells the CA communication network 100 that there is an unwanted overlapping coverage which may also result in interference between NWs and that replanning could/should be considered. With this location awareness, the CA communication network 100 can also be configured to maintain cell configurations for Inter-NW areas but allow dynamic configuration of Intra-NW areas to maximize network efficiency without requiring planning updates.

By means of the present disclosure, unnecessary neighbor relations are reduced, reducing signaling loads, contexts in memory etc. Furthermore, an improved planning independency is obtained between the CA communication network 100 and the external communication networks 150, 151, 152; the number of cells can be limited where co-planning is needed. There is also a reduced need for UEs to measure on neighbors, saving power and signaling resources, and many unnecessary handovers between the CA communication network 100 and the external communication networks 150, 151, 152 are avoided.

With reference to FIG. 1-FIG. 4 and FIG. 11, there is a control arrangement 200 adapted to control a confined area, CA, communication network 100 that is adapted to serve a pre-defined area 101 that comprises a plurality of sub-areas 110, 111, 112, 113, 114, 115, 116, 117, 118; 120, 121, 122. Each sub-area 110, 111, 112, 113, 114, 115, 116, 117, 118; 120, 121, 122 is covered by a corresponding antenna arrangement 510.

The control arrangement comprises a serving unit X100 that is configured to serve a pre-defined area 101 that comprises a plurality of sub-areas 110, 111, 112, 113, 114, 115, 116, 117, 118; 120, 121, 122, where each sub-area 110, 111, 112, 113, 114, 115, 116, 117, 118; 120, 121, 122 is covered by a corresponding antenna arrangement 510. The control arrangement further comprises a communicating unit X200 that is adapted to communicate with one or more pieces of internal user equipment 140, 141, 142, UEs, within the CA communication network 100 and with at least one external communication network 150, 151, 152, and an associating unit X300 that is adapted to associate at least one of the internal UEs 140, 141, 142 within the CA communication network 100 with a corresponding specific sub-area 110, 111, 112, 113, 114, 115, 116, 117, 118; 120, 121, 122 in the plurality of sub-areas 110, 111, 112, 113, 114, 115, 116, 117, 118; 120, 121, 122.

According to some aspects, the control arrangement 200 comprises a relating unit X400 that is adapted to relate signaling for a certain UE 140, 141, 142; 143 either to a unique identity of the specific sub-area 110, 111, 112, 113, 114, 115, 116, 117, 118; 120, 121, 122 in which the UE 140, 141, 142; 143 is served, or to a unique identity of the specific sub-area 110, 111, 112, 113, 114, 115, 116, 117, 118; 120, 121, 122 in which the UE 140, 141, 142; 143 requests to be served.

According to some aspects, the control arrangement 200 comprises a first forming unit X500 that is adapted to form cells 310; 410, 411, 412, 413, 414, 415, 416, 417 using the sub-areas 110, 111, 112, 113, 114, 115, 116, 117, 118; 120, 121, 122 and corresponding unique identities for the sub-areas 110, 111, 112, 113, 114, 115, 116, 117, 118; 120, 121, 122, a conferring unit X600 that is adapted to confer a unique cell identity to each cell, and a second forming unit X700 that is adapted to form the cells 310; 410, 411, 412, 413, 414, 415, 416, 417 adaptively in dependence of a current need for wireless communication in the pre-defined area 101.

According to some aspects, the control arrangement 200 comprises a receiving unit X800 that is adapted to receive signaling regarding mobility for a certain external UE 143 that is served by an external communication network 150, 151, 152 from the external communication network 150, 151, 152; 260, where the external UE 143 requests to be served by a cell 310; 410, 411, 412, 413, 414, 415, 416, 417 in the CA communication network 100, where the received signaling comprises information regarding a unique cell identity of the specific cell 310; 410, 411, 412, 413, 414, 415, 416, 417 in which the external UE 143 requests to be served.

According to some aspects, the control arrangement 200 comprises an admitting unit X900 that is adapted to admit handover for a UE 140, 141, 142 between the CA communication network 100 and the external communication network 150, 151, 152 only for sub-areas 120, 121, 122 that comprise an exit and/or entrance 160, 161, 162, 163 to the pre-defined area 101.

1. A control arrangement adapted to control a confined area, (CA) communication network that is adapted to serve a pre-defined area that comprises a plurality of sub-areas, where each sub-area is covered by a corresponding antenna arrangement, the control arrangement comprising:
memory; and
processing circuitry, wherein the control arrangement is operable to:
communicate with one or more user equipments (UEs) within the CA communication network, and with at least one external communication network; and
associate at least one of the internal UEs within the CA communication network with a corresponding specific sub-area in the plurality of sub-areas.

2. The control arrangement of claim 1, wherein
the control arrangement is adapted to relate signaling for a certain UE either to a unique identity of the specific sub-area in which the UE is served, or to a unique identity of the specific sub-area in which the UE requests to be served.

3. The control arrangement of claim 1, wherein
the control arrangement is adapted to form cells using the sub-areas and corresponding unique identities for the sub-areas, where the control arrangement is adapted to confer a unique cell identity to each cell, and to form the cells adaptively in dependence of a current need for wireless communication in the pre-defined area.

4. The control arrangement of claim 3, wherein
the control arrangement is adapted to receive signaling regarding mobility for a certain external UE that is served by an external communication network from the external communication network,
the external UE requests to be served by a cell in the CA communication network, and
the received signaling comprises information regarding a unique cell identity of the specific cell in which the external UE requests to be served.

5. The control arrangement of claim 1, wherein
the control arrangement is adapted to receive signaling regarding mobility for a certain internal UE that is served by a specific sub-area in the CA communication network, and
the received signaling comprises a unique identity regarding the specific sub-area where the internal UE is served.

6. The control arrangement of claim 1, wherein
the mobility comprises handover between the CA communication network and the external communication network, and
the control arrangement is adapted to admit handover for a UE between the CA communication network and the external communication network only for a subset of the sub-areas.

7. The control arrangement of claim 1, wherein
the control arrangement is adapted to admit handover for a UE between the CA communication network and the external communication network only for sub-areas that comprise an exit and/or entrance to the pre-defined area

8. The control arrangement of claim 1, wherein
the control arrangement is adapted to exchange information with the external communication network, and the information comprises data regarding one or more UEs that are candidates for handover between the CA communication network and the external communication network.

9. The control arrangement of claim 1, wherein
the control arrangement is adapted to periodically or continuously determine in which sub-area in the pre-defined area a UE is present.

10. The control arrangement of claim 1, wherein
the control arrangement is adapted to instruct UEs, determined to be present in sub-areas where handover for the UEs between the CA communication network and the external communication network is not admitted, to refrain from:
signaling to the external communication network,
initializing handover, and/or
performing channel measurements.

11. The control arrangement of claim 1, wherein
the control arrangement comprises a communication interface arrangement that is adapted to receive information regarding for which sub-areas, handover for a UE between the CA communication network and the external communication network is admitted.

12. The control arrangement of claim 11, wherein
the communication interface arrangement is adapted for communication between the control arrangement and the radio units and the external communication network.

13. The control arrangement of claim 11, wherein
the communication interface arrangement comprises two or more separate communication interfaces.

14. The control arrangement of claim 1, wherein
the control arrangement comprises a memory storage unit and processing circuitry.

15. The control arrangement of claim 1, wherein
the control arrangement is adapted to form cells using those sub-areas where handover for the UEs between the CA communication network and the external communication network is not admitted.

16. A control arrangement adapted to control a confined area, (CA) communication network that is adapted to serve a pre-defined area that comprises a plurality of sub-areas, where each sub-area is covered by a corresponding antenna arrangement, where the control arrangement comprising:
processing circuitry; and
a storage medium, wherein the control arrangement is configured to perform a method comprising:
communicating with one or more internal user equipments (UEs) within the CA communication network;
communicating with at least one external communication network; and
associating at least one of the internal UEs within the CA communication network with a corresponding specific sub-area in the plurality of sub-areas.

17. The control arrangement of claim 16, wherein
the control arrangement is adapted to relate signaling for a certain UE either to a unique identity of the specific sub-area in which the UE is served, or to a unique identity of the specific sub-area in which the UE requests to be served.

18. A confined area (CA) communication network that is adapted to serve a pre-defined area that comprises a plurality of sub-areas, the CA communication network comprising the control arrangement of claim 1 and a plurality of radio units, each radio unit comprising at least one antenna arrangement and a transceiver unit, where each antenna arrangement is adapted to cover a certain sub-area.

19. The CA communication network of claim 18, wherein at least one antenna arrangement comprises two or more separate antenna units.

20. A confined area, (CA) communication network system comprising the CA communication network of claim 18 and a remote server, where the communication interface arrangement is adapted for communication between the control arrangement and the remote server.

21-34. (canceled)
